(19) United States
(12) Patent Application Publication
(10) Pub. No.: US 2021/0376361 A1
(43) Pub. Date: Dec. 2, 2021

(54) METHOD AND SYSTEM FOR POWER GENERATION WITH FUEL CELL

(71) Applicant: INOVA CLEAN ENERGY SYSTEMS LTD., Airdrie (CA)

(72) Inventor: Marc Marcel DIONNE, Airdrie (CA)

(21) Appl. No.: 17/329,665

(22) Filed: May 25, 2021

(30) Foreign Application Priority Data
May 27, 2020 (CA) 3081442

(51) Int. Cl. H01M 8/0612; H01M 8/12; H01M 8/04014; H01M 8/04537; H01M 8/04225; C01B 3/38

(52) U.S. Cl. CPC H01M 8/0618; H01M 8/12; H01M 8/04022; H01M 8/04619; H01M 2008/1293; H01M 8/04589; H01M 8/04225; C01B 3/386; C01B 2203/067; H01M 8/04559

(57) ABSTRACT

Power generation systems and methods using solid oxide fuel cell(s) (SOFC) are provided. For example, a power generation system can include a catalytic partial oxidation (CPOx) reactor, an array of one or more fuel cell stacks, and a self-diagnostic system. The CPOx reactor is operable to generate a hydrogen rich gas from a hydrocarbon fuel. The array of one or more fuel cell stacks includes at least one SOFC and is coupled to the CPOx reactor. The fuel cell stacks are operable to generate electrical power and heat from an electrochemical reaction of the hydrogen rich gas and oxygen from an oxygen source. This power generation system can be composed of off-the-shelf parts and components, making this unit inexpensive to manufacture, operate and to maintain as well as easier to operate.

### TECHNICAL FIELD

The technical field relates to power generation methods and systems, and more particularly to a Solid Oxide Fuel Cell (SOFC) power generation system composed of primarily off-the-shelf components.

### BACKGROUND

In populated areas, electricity is typically provided through a power grid. In more remote areas, however, a power grid may not be available. For example, in remote locations where oil and gas exploration are present, electrical power may be required to operate equipment, and a conventional source of electricity may not be available. An electrical generator can be used to produce electricity, for example, by using one or more motors to convert mechanical energy to electrical energy. Fuel cell technology uses an electrochemical reaction between a fuel and an oxidant in the presence of an electrolyte to produce electricity. A portable fuel cell power system can also be used to generate electricity, for example, in a location without access to a power grid or during times of a power grid outage.

### SUMMARY

Power generation systems and methods are described. In general, in one aspect, the technology features a power generation system with solid oxide fuel cell (SOFC) method. In accordance with one embodiment of the disclosure, a power generation system includes a partial oxidation (POx) reactor, an array of one or more fuel cell stacks and an external burner. The POx reactor is operable to generate a hydrogen rich and carbon monoxide rich gas from a hydrocarbon fuel. The array of one or more fuel cell stacks includes at least one SOFC and is coupled to the POx reactor. The fuel cell stacks are operable to generate electrical power and heat from an electro-chemical reaction of the hydrogen/carbon dioxide rich gas and oxygen from an oxygen source.

In particular embodiments, the POx reactor may be a catalytic partial oxidation (CPOx) reactor. The oxygen source may be preheated air and the fuel may be natural gas. Heat generated by the fuel cell stacks may include radiant heat from the stacks, convective heat from the stacks, conductive heat from the stacks and heat from exhaust gases produced by the stacks. The POx reactor may also generate heat. In addition, a power conditioning unit may be provided to receive and condition electrical power from the fuel cell stacks to provide conditioned power to a load.

In accordance with another embodiment of the present disclosure, the power generation system may include any suitable reformer reactor operable to generate hydrogen rich gas from fuel. The reformer reactor may be, for example, a steam reformer, an auto thermal reformer (ATR) or a water-independent reformer. In still another embodiment, the POx reactor and/or reformer reactor may be omitted, and a hydrogen rich gas source provided directly to the system.

In accordance with another embodiment of the disclosure, a power generation system includes the partial oxidation (POx) reactor, an array of one or more fuel cell stacks and a power conditioning unit (PCU). The POx reactor is operable to generate a hydrogen/carbon monoxide rich gas from a hydrocarbon fuel. The array of fuel cell stacks includes at least one SOFC and is coupled to the POx reactor. The array of fuel cells is operable to generate electrical power for a load from an electro-chemical reaction of the hydrogen rich gas and oxygen from an oxygen source. The PCU is operable to receive and condition electrical power from the array of fuel cell stacks and to provide at least 5 watts (Wₑ) electrical power to the load.

In other embodiments of the present disclosure, the PCU may provide at least 5 Wₑ of power to the load, 5 kWₑ power to the load, or 10 kWₑ power to the load.

In accordance with another aspect of the present disclosure, a power generation system may include a POx reactor and a plurality of fuel cell stacks arranged near the POx reactor. In this embodiment, the POx reactor may generate a hydrogen rich gas from a fuel. The fuel cell stacks may be coupled to the POx reactor and operable to generate electrical power for a load from an electro-chemical reaction of the hydrogen rich gas and oxygen from an oxygen source.

In accordance with still another aspect of the present disclosure, a power generation system may include a POx reactor, a heat exchanger disposed approximate to the POx reactor or burner, a plurality of fuel cell stacks. The POx reactor is operable to generate hydrogen rich gas from a fuel. The heat exchanger is operable to heat oxygen from an oxygen source to a suitable level. The fuel cell stacks include at least one SOFC and are arranged around the burner. The fuel cell stacks may be coupled to the POx reactor and operable to generate electrical power for a load from an electro-chemical reaction of the hydrogen rich gas and the oxygen heated to the operational level.

In general, in another aspect, there is provided a power generation system including a POx reactor, an array of one or more fuel cell stacks and a control unit. The POx reactor is operable to generate a hydrogen rich gas from a hydrocarbon fuel. Each fuel cell stack includes at least one solid oxide fuel cell (SOFC). The array is coupled to the POx reactor and operable to generate electrical power for a load from an electro-chemical reaction of the hydrogen rich gas and oxygen from an oxygen source. The control unit is operable to control a feed of hydrogen rich gas and a feed of oxygen to the array of fuel cell stacks to maintain an output of power from the array of fuel cell stacks for at least 12 months.

Implementations of the system can include one or more of the following features. The POx reactor can be a catalytic partial oxidation (CPOx) reactor.

The control unit can be further operable to monitor a voltage output from the array of fuel cell stacks and to control the feed of hydrogen rich gas based on the monitored voltage output to maintain an output of power. The control unit can be further operable to monitor a voltage output from each of the fuel cell stacks in the array of fuel cell stacks. The control unit can be further operable to monitor a current output from the array of fuel cell stacks to control the feed of oxygen based on the monitored current output to maintain the substantially constant output of power. The control unit will ensure that the constant power output meets the required electrical load to within 1%. If the power generated is below the required electrical load, the power generation system will be ramped up to produce the necessary power; however, if the power generated is greated than the required electrical load then the surplus will be absorbed by the batteries and other electrical parasitic subsystems within the power generation system. The control unit can be further operable to control a feed of hydrogen rich gas and a feed of oxygen to the array of fuel cell stacks to maintain an output of power from the array of fuel cell stacks for at least 12 months.

The fuel can be, for example, methane, natural gas or propane for future units with CPOx reformed designed to reform propane. The array of fuel cell stacks can include a plurality of fuel cell stacks and the POx reactor can be positioned within a thermal zone of the plurality of fuel cell stacks. The oxygen source can be air.

The power generation system can further include a power conditioning unit (PCU) operable to receive and condition electrical power from the array of fuel cell stacks and to provide the conditioned power to a load.

In general, in another aspect, there is provided a power generation system including a reformer reactor, an array of one or more fuel cell stacks and a controller. The reformer reactor is operable to generate a hydrogen rich gas from a fuel. Each fuel cell stack includes at least one electrochemical fuel cell. The array is coupled to the reformer reactor and operable to generate electrical power and heat from an electrochemical reaction of the hydrogen rich gas and oxygen from an oxygen source.

The array of fuel cell stacks can include a plurality of fuel cell stacks and the reformer reactor can be positioned within a thermal zone of the plurality of fuel cell stacks. The oxygen source can be air. The power generation system can further include a power conditioning unit (PCU) operable to receive and condition electrical power from the array of fuel cell stacks and to provide the conditioned power to a load.

In general, in another aspect, there is provided a power generation system including a reformer reactor, an array of one or more fuel cell stacks and a heat. The reformer reactor is operable to generate a hydrogen rich gas from a fuel. Each fuel cell stack includes at least one electrochemical fuel cell. The array is operable to generate electrical power and heat from an electrochemical reaction of the hydrogen rich gas and oxygen from an oxygen source. The heat source is operable to warm the array of fuel cell stacks during a start-up operation.

Implementations of the power generation system can include one or more of the following features. The reformer reactor can be a partial oxidation (POx) reactor, which in one example is a catalytic partial oxidation (CPOx) reactor. The heat source can be a battery operated heater, a gas-operated heater and/or can include heat generated by the reformer reactor. The fuel can be natural gas or methane. The electrochemical fuel cell can be a solid oxide fuel cell (SOFC) or a high temperature ceramic fuel cell. The oxygen source can be air. The power generation system can further include a power conditioning unit (PCU) operable to receive and condition electrical power from the array of fuel cell stacks.

In general, in another aspect, there is provided a power generation system including a reformer reactor, an array of one or more fuel cell stacks and a burner. The reformer reactor is operable independent of water to generate a hydrogen rich gas from a fuel. Each fuel cell stack includes at least one electrochemical fuel cell. The array is coupled to the reformer reactor and operable to generate electrical power and heat from an electrochemical reaction of the hydrogen rich gas and oxygen from an oxygen source. The burner is independent of the fuel cell stacks and is used primarily to heat up the system.

Implementations of the power generation system can include one or more of the following features. The reformer reactor can be a partial oxidation (POx) reactor or a catalytic partial oxidation (CPOx) reactor. The heat generated by the array of fuel cell stacks can include radiant heat generated by the one or more fuel cell stacks, conductive heat from one or more fuel cell stacks, convective heat from one or more fuel cell stacks and heat from exhaust gases produced by the one or more fuel cell stacks. The reformer reactor can generate heat. The array of fuel cell stacks can include a plurality of fuel cell stacks and the reformer reactor can be positioned within a thermal zone of the plurality of fuel cell stacks. At least one electrochemical fuel cell can include a solid oxide fuel cell (SOFC). The power generation system can further include a power conditioning unit (PCU) operable to receive and condition electrical power from the array of fuel cell stacks to provide the conditioned power to a load. The fuel can be natural gas or methane. The oxygen source can be air.

In general, in another aspect, there is provided a power generation system including a reformer reactor operable to generate a hydrogen rich gas from a fuel, an array of one or more fuel cell stacks, a burner and a controller. Each fuel cell stack includes at least one electrochemical fuel cell. The array is coupled to the reformer reactor and operable to generate electrical power and heat from an electrochemical reaction of the hydrogen rich gas and oxygen from an oxygen source. The burner is independent to the array of fuel cell stacks and operable to generate heat during start-up conditions. The controller is operable to control operation of the power generation system. The controller includes a self-diagnostic unit operable to detect a fault.

Implementations of the power generation system can include one or more of the following features. The heat generated by the array of fuel cell stacks can include radiant heat generated by the one or more fuel cell stacks, conductive heat from one or more fuel cell stacks, convective heat from one or more fuel cell stacks and heat from exhaust gases produced by the one or more fuel cell stacks. The electrical power output from the array of fuel cell stacks can be in the range of approximately 5 W to 10 kW. The fault can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

The power generation system can further include one or more sensors that are operable to communicate with the self-diagnostic unit. The one or more sensors can be wireless sensors. The power generation system can further include a remote control unit, where the remote control unit is operable to: communicate with the controller over the network; and transmit instructions to control operation of the power generation system to the controller over the network. The power generation system can further include a power conditioning unit (PCU) operable to receive and condition electrical power from the array of fuel cell stacks to provide the conditioned power to a load.

The details of various embodiments are set forth in the accompanying drawings and the description below. Other features, objects, and advantages of the technology will be apparent from the description and drawings, and from the claims.

### BRIEF DESCRIPTION OF DRAWINGS

FIG. 1A is a schematic block diagram of an example power generation system.

FIGS. 1B-D are graphs illustrating the relationship between power generation and current in the example power generation system of FIG. 1A.

FIG. 2 is a schematic representation of an example reformer reactor.

FIG. 3A is a schematic representation of a simplified example fuel cell.

FIG. 3B is a schematic representation of an example fuel cell stack.

FIG. 4 is a flow diagram of an example system.

FIG. 5 is a schematic representation of an example power conditioning unit.

FIG. 6 is a schematic block diagram of a specific embodiment of a power generation system.

FIGS. 7A-C show different views of the power generation system of FIG. 6 as configured in a portable power generation unit.

FIG. 8 is a flow diagram illustrating an example method of operating a power generation system.

FIG. 9 is a flow diagram illustrating an example method for performing the start-up mode of FIG. 8.

FIG. 10 is a flow diagram illustrating an example method for performing the pre-run mode of FIG. 8.

FIG. 11 is a flow diagram illustrating an example method for performing the run mode of FIG. 8.

FIG. 12 is a flow diagram illustrating an example method for performing the shut-down mode of FIG. 8.

Like reference symbols in the various drawings indicate like elements.

### DETAILED DESCRIPTION

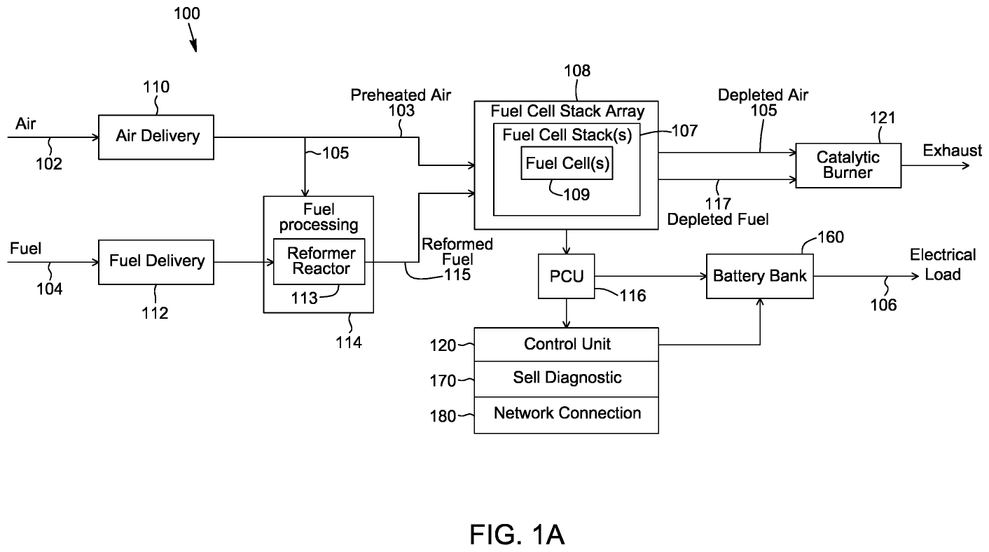

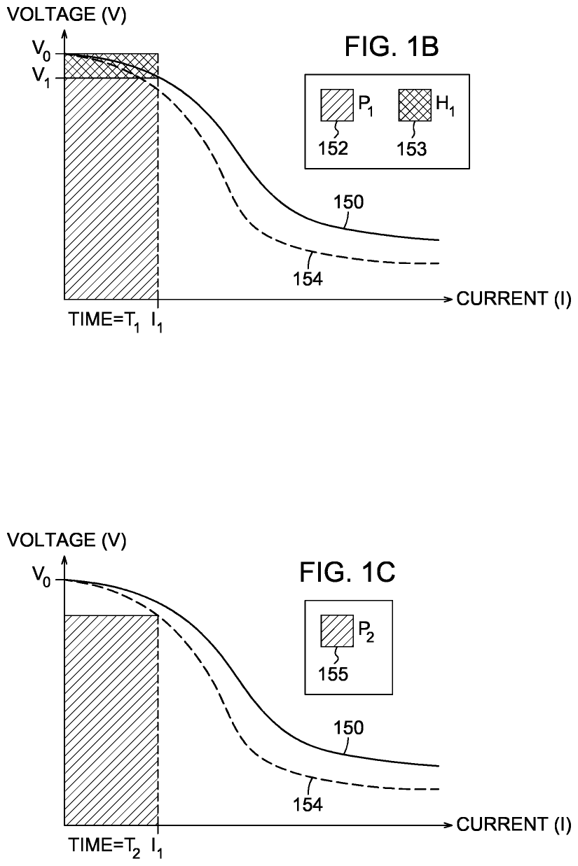

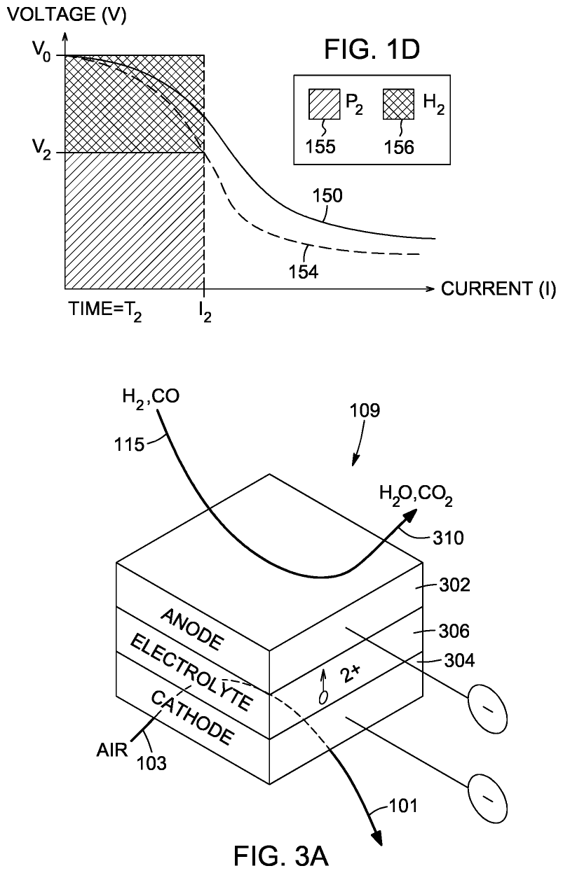

FIG. 1A is a schematic representation of an example implementation of a power generation system 100. A source of oxygen, which in this implementation is air 102, and fuel 104 are inputs into the system 100 and electrical power 106 is an output of the system 100. A fuel cell stack array 108 generates the electrical power 106 and waste heat from an electro-chemical reaction of the air 102 and fuel 104. The fuel cell stack array 108 can include one or more fuel cell stacks 107, where each fuel cell stack includes one or more fuel cells 109.

The air 102 is input into an air delivery system 110 coupled to the fuel cell stack array 108. The air delivery system 110 is operable to preheat the air to a suitable temperature for delivery to the fuel cell stack array 108 to avoid thermally shocking the one or more fuel cells 109 included in the array. For example, where each fuel cell stack 107 includes one or more ceramic fuel cells, a thermal shock to the stack 107 can crack the ceramic plate included in the fuel cell 109. The air is preferably pre-heated to just below the operating temperature of the fuel cell stack array 108. In some implementations, the air delivery system 110 includes one or more heat exchangers arranged in series. The heat exchanger(s) can be coil exchangers, shell and tube and/or plate and fin exchangers, or otherwise configured. It should be noted that although in the example implementation shown, pre-heated air 103 is input into the fuel cell stack array 108, in other implementations an oxygen source other than air can be used, for example, pure oxygen.

In the implementation shown, the fuel 104 is input into a fuel delivery system 112. The fuel delivery system 112 can include one or more pressure drop down valves for pressure reduction, for example, if the fuel is being received from a pipeline at a relatively high pressure. In some implementations, the fuel delivery system 112 includes a desulphurizer. For example, if the fuel 104 is natural gas, the desulphurizer can be used to remove mercaptan(s) added to the natural gas to provide an odor for leak detection.

The fuel is delivered to a fuel processing system 114. The fuel processing system 114 includes a reformer reactor 113 operable to generate a hydrogen rich gas 115 from the fuel 104. In some implementations, the reformer reactor 113 is a partial oxidation (POx) reformer. In a particular example, the reformer reactor is a catalytic partial oxidation reformer (CPOx).

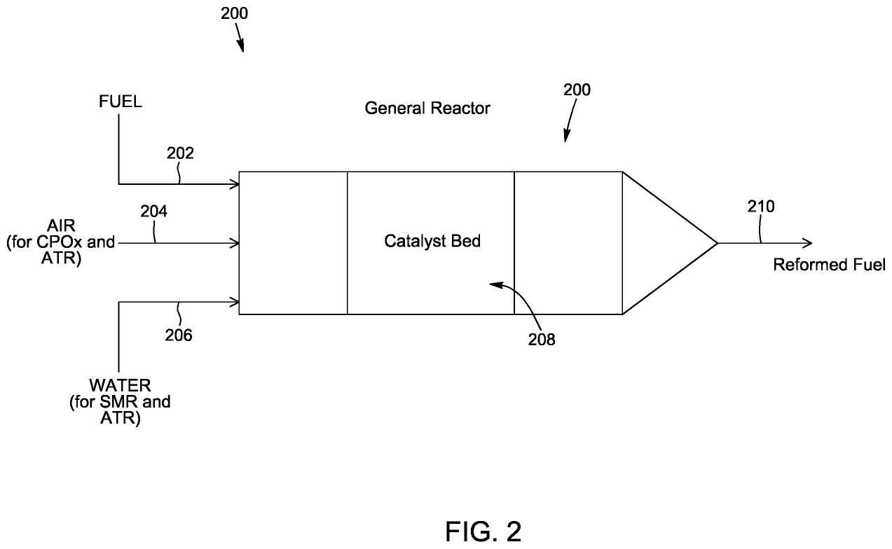

Referring to FIG. 2, a schematic representation of an example reformer reactor 200 is shown for illustrative purposes. Examples of different reformer reactors that can be used include a Partial Oxidation reactor (POx) (e.g., a Catalytic Partial Oxidation reactor (CPOx), a Steam Methane Reformer (SMR) and an Auto Thermal Reactor (ATR) and Prereformer (PR). Inputs to the reformer reactor depend on the type of reformer reactor. For example, POx and CPOx reformer reactors have fuel 202 and air 204 as inputs. An ATR reformer reactor has fuel 202, air 204 and water 206 as inputs. An SMR reformer reactor has fuel 202 and water 206 as inputs. The reformer reactor is used for converting hydrocarbon gases (e.g., natural gas, methane or propane) to a hydrogen and carbon monoxide rich stream, i.e., reformate 210. These two gas species are consumed by oxygen within fuel cell stacks to produce electricity. The fuel conversion can be performed within the reformer reactor by either a water gas shift reaction or partial oxidation reactions. The reformer reactor 200 includes a catalyst bed 208 which can selectively enhance the chemical conversion to hydrogen and carbon monoxide.

All of the above mentioned reformers are not 100% efficient; hence, the reactor yield is below 100% signifying that not all of the hydrocarbon fuel is reformed within the reactor. The remainder of the fuel is converted on cell within the SOFC stacks. This is what is called “on cell reforming”.

Referring again to FIG. 1A, the reformer reactor 113 can reform a fuel 104 of natural gas into a hydrogen rich gas 115 including hydrogen (H₂) and carbon monoxide (CO). By way of example, the hydrogen rich gas 115 can be approximately 53% hydrogen. As discussed above, configurations of reformer reactor 113 other than POx reactor can be used, for example, an autothermal reformer (ATR) or a steam methane reformer (SMR). The selection of reformer reactor can depend on the application for which the power generation system is being used. For example, an autothermal reformer and a steam reformer both use water, and are therefore not preferred for use in an environment having ambient temperatures substantially below freezing. By contrast, the POx or CPOx reformer, or another type of water-independent reformer, are preferred for such an environment, since concerns about freezing the water required to operate the reformer reactor can be eliminated.

In an implementation where the reformer reactor 113 is exothermic, for example, a CPOx reformer, waste heat generated by the reformer reactor along with heat generated by the fuel cell stack array 108 can be used to provide heat to a heat exchanger included in the air delivery system 110. For example, a CPOx reformer typically has a cylindrical shape, and a heat exchanger can be wrapped around the exterior of the CPOx reformer and thereby heat the air 102, at least in part, using the waste heat generated by the CPOx reformer.

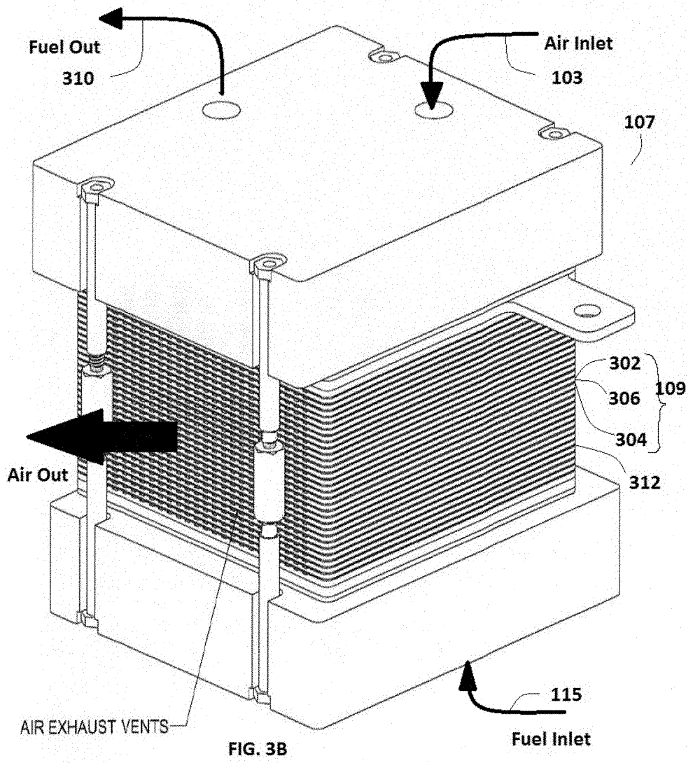

The pre-heated air 103 and the hydrogen rich gas 115 are input to the fuel cell stack array 108, which includes one or more fuel cell stacks 107. Each fuel cell stack includes one or more fuel cells 109, and is an electrochemical conversion device operable to generate electrical power from fuel and oxygen, in this implementation, the hydrogen rich gas 115 and the pre-heated air 103. Referring to FIG. 3A, a schematic representation of a simplified fuel cell 109 is shown for illustrative purposes. Generally, a fuel cell includes an anode 302 and a cathode 304 separated by an electrolyte 306. The hydrogen rich gas 115 is supplied to the anode 302. The oxygen in 103 reacts with the cathode 304 and separates into two charged oxygen ions. The oxygen ions migrate across the electrolyte 306 into the anode and react with the hydrogen and the carbon monoxide (also included in the hydrogen rich gas) to form water and carbon dioxide 310. The electrons from the oxygen atoms build up a negative charge in the cathode 304 creating an electrical current from cathode to anode.

There are different types of fuel cells and they are typically classified by the electrolyte used in the fuel cell. A solid oxide fuel cell (SOFC) typically uses a ceramic material as an electrolyte. The power generation system 100 can use different types of fuel cells, including without limitation the following: SOFC, phosphoric acid fuel cells (PAFCs), molten carbonate fuel cells (MCFCs), proton exchange membranes (PEMs), alkaline fuel cells (AFCs), direct methanol fuel cells (DMFCs), and protonic ceramic fuel cells (PCFCs) or solid oxide electrolyzer fuel cells (SOECs). Each of these fuel cell type will dictate the system inputs required to operate the system.

Referring to FIG. 3B, FIG. 3A and FIG. 3C, a schematic representation is shown of an example implementation of a fuel cell stack 107, in a rectangular form with the anode exhaust leaving the stack through ports on the side of the stack. Note that a fuel cell stack 107 may be of circular, rectangular or other polygonal cross section with similar operating features. The fuel cell stack 107 includes multiple fuel cells, in this example, each fuel cell (FIG. 3B) is a SOFC having a planar ceramic unit that includes the anode 302, cathode 304 and electrolyte 306. A metallic interconnect 312 is a metallic collector of the electrical power generated by the fuel cells 109. The metallic interconnect 312 is also constructed planar. Both the ceramic unit (302+306+304) and the metallic interconnect 312 include a series of apertures for the fuel supply, i.e., the hydrogen rich gas 115. In the example stack 107 shown, there are thirty SOFCs stacked on top of one another. In practice, the number of SOFCs included in a fuel cell stack can vary, depending on the power output requirements, for example, 60 SOFCs can be used to supply an output electrical power of 1 kW or more for a typical thermal/energy input of about 2.5 kW.

The metallic interconnect 312 ensures the electrical contact between the individual SOFCs 109 included in the stack 107. The metallic interconnect 312 is further operable to distribute gases on the surface of the electrode, seal the gas flow against the air flow and ensure spent air exhausting out the stack side via the cell ports. The hydrogen rich gas 115 flows laterally along the channel at the anode side of the SOFCs towards the outside. Simultaneously, the preheated air 103 flows from the outside into the interior of the stack through channels on the metallic interconnect 312 (in this example, can be eight channels) and is redirected in order to flow laterally over the cathode side of the SOFCs to the outside. Hydrogen rich gas 115 that is not converted on the anode 302 can be exhausted to the anode exhaust manifold at the bottom edge of the fuel cell stack 109. Preheated air 103 that is not converted on the cathode 304 is exhausted to the hotbox environment via the interconnect ports at the edge of the fuel cell 109. The afterburning of the fuel with the spent air occurs outside of the hotbox through the catalytic converter.

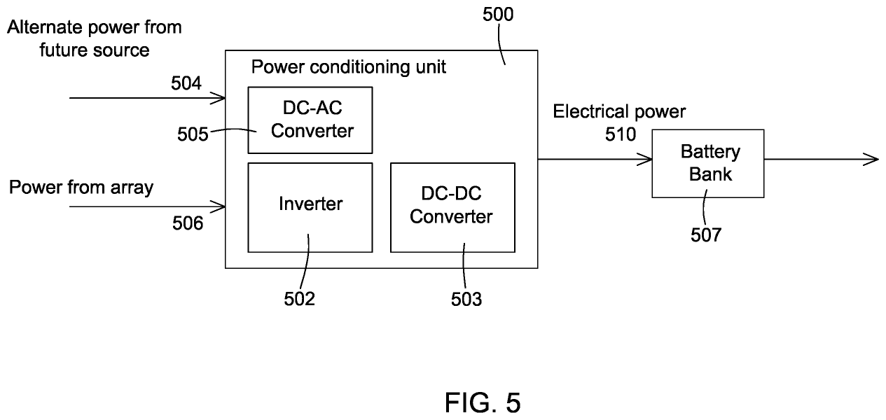

Referring to FIG. 3C, a schematic representation is shown of an example implementation of a series of fuel cells (302, 304, 306 and 312) within a fuel cell stack 107 in a rectangular form with internal ducting. Note that a fuel cell stack 107 may be of circular, rectangular or other polygonal cross section with similar operating features. The fuel cell stack 107 (in FIGS. 3B and 3C) includes multiple fuel cells, in this example, each fuel cell is a SOFC having a planar ceramic unit that includes the anode 302, cathode 304 and electrolyte 306. A metallic interconnect 312 is a metallic collector of the electrical power generated by the fuel cells 109. The metallic interconnect 312 is also planar. Both the ceramic unit, 302, 304, 306 and the metallic interconnect 312 include apertures at the edges forming a channel 316 for the fuel supply, i.e., the hydrogen rich gas 115, a channel for the fuel outlet, a channel for the preheated air 103, and a channel for the air outlet 105. In the example stack 107 shown, there is one SOFC repeating cell unit shown. In practice, the number of SOFCs included in a fuel cell stack can vary, depending on the power output requirements, for example, 60 SOFCs can be used to supply an electrical power of 1 kW or more for a thermal/chemical input of about 2.5 kW. The metallic interconnect 312 ensures the electrical contact between the individual SOFCs 109 included in the stack 107. The metallic interconnect 312 is further operable to distribute gases on the surface of the electrode, seal the gas flow against the air flow and enable the collection and ducting of the depleted outlet fuel and the depleted outlet air to the catalytic converter. The hydrogen depleted gas 310 pours out of the channel at the anode end of the SOFC stack 107 to the collection manifold and then to the catalytic converter. Simultaneously, the preheated air 103 flows from the outside into the interior of the stack through channels on the metallic interconnect 312 and is redirected in order to flow over the cathode end of the SOFCs to the collection manifold and then to the catalytic converter. Hydrogen rich gas 115 that is not converted on the anode 302, and preheated air 103 that is not converted on the cathode 304, can be consumed in the catalytic converter. Referring again to FIG. 1A, the fuel cell stack array 108 can generate a DC current. In the implementation shown, the fuel cell stack array 108 is coupled to a power conditioning unit (PCU) 116. The PCU 116 is operable to condition the output from the fuel cell stack array 108 in accordance with desired output requirements for the power generation system 100. For example, if the power generation system 100 is required to produce an AC current, the PCU 116 can include an inverter to change the DC output from the fuel cell stack array 108 into an AC current. In another example, the PCU 116 can be used to condition the voltage of the output, according to the load on the system 100. Referring to FIG. 5, a schematic representation of an example implementation of a Power Conditioning Unit PCU 500 (e.g., PCU 116) is shown for illustrative purposes. The PCU 500 includes an inverter 502, and DC-DC converter 503 and/or, a DC-AC converter 505. Input to the PCU 500 can include power 504 from the HRU (possible future iteration), and power 506 from the array of fuel cell stacks 108. The controller 120 controls the flows and pressures of fuel, air and thus temperatures within the entire system 100. Power generated from the battery bank 508, the array of fuel cell stacks 108 is monitored and passed to the PCU 500, which converts this to a usable type and state for the customer load and internal power requirements. The PCU 500 may contain any or all of the following sub-components, a DC-AC Inverter, a DC-DC converter and/or an AC-DC converter.

Referring again to FIG. 1A, the system 100 can include a control unit 120 operable to control one or more operating parameters of the system 100. Certain variables can be monitored within the system 100, and based on the values of one or more variables, the control unit 120 can adjust the operating parameters to achieve a desired output. For example, the temperature, pressure, voltage and current at one or more locations within the system 100 can be monitored. Operating parameters, including for example, the flow rate of the air and/or fuel into the system 100 can be adjusted.

In some implementations, the power generation system 100 is used to provide a substantially constant power output, e.g., as contrasted to a system that provides a substantially constant voltage output with a decreasing power output over time. Referring to FIG. 1B, a simplified graph is shown to depict the relationship between the voltage and current of a fuel cell stack 107 included in the fuel cell stack array 108. The curve 150 represents the relationship at time T₁, which is before the fuel cells 109 included in the fuel cell stack array 108 have degraded. The area under the curve represents the electrical power output of the fuel cell stack 107 when generating a particular current. For example, at time T₁ when the current generated by the fuel cell stack 107 is I₁, then the power output is P₁ represented by the area 152, when P₁ is simply the product of V₁ and I₁. The area represented by 153 is the heat produced at the beginning of life condition.

However, over time as the one or more fuel cells 109 included in the stack 107 degrade, the curve 150 shifts. An example shifted curve 154 at time T₂ is shown as a broken line, to represent the relationship between the voltage and current at a later time during the lifecycle of the fuel cells 109. Referring to FIG. 1C, the later time T₂, when the fuel cells 109 have degraded, the power output P₂ (as is illustrated by the area 155) is less for the same current I₁. That is the area P₂ is smaller than the area P₁. To maintain a constant power output, the control unit 120 can be operable to adjust the flow rate of fuel 104 and/or air 102 input into the system to increase the current generated by the fuel cell stack array 108. The fuel cells 109 continue to degrade over time until such time as the operational voltage produced by the fuel cell stack array 108 no longer meets the requirements of the PCU, thereby necessitating a stack changeout.

The increased current can compensate for the degradation of the fuel cells 109 to maintain a substantially constant power output, as illustrated by FIG. 1D. In FIG. 1D, at the later time T₂, the current is increased to I₂. The power generated by the fuel cell stack 107 when the current is I₂ is represented by P₂′, the area under the curve 154. The area P₂′ is equal to the area P₁, and thus a constant power output has been maintained, in spite of the degrading fuel cells 109. There comes a point in time where the fuel cell stack 107 should be changed out because the generating voltage is too low for the PCU 116 to function properly.

Referring again to FIG. 1B, the area above the curve 150 formed by a horizontal line extending from the initial operating voltage V₀, that is, area H₁ 153, represents the heat generated by the fuel cell stack array 108. Referring to FIG. 1D, the increase in heat generated over time as the current is increased is illustrated. That is, the heat H₂ 156 generated at time T₂ is substantially greater than the heat H₁ generated at time T₁. This heat generated by the fuel cell stack array 108 can be recovered by alternative technology, as discussed above, and used to generate electrical power. The more electrical power generated by the alternative technology, the less power required to be generated by the fuel cell stack array 108 to maintain a substantially constant power output, thereby prolonging the life of the fuel cells 109 included in the array 108.

In some implementations, the control unit 120 (FIG. 1A) is operable to monitor a voltage output from the fuel cell stack array 108 and to control the feed of hydrogen rich gas 115 and/or pre-heated air 103 to the array 108 based on the monitored current and voltage. The estimated relationship between the voltage and current based on an estimated degradation of the fuel cell stack at a given time, i.e., the shifted curve 154 for the given time, can be used together with the monitored voltage by the control unit 120 to determine a modified level of current output required to meet the power output requirements. The control unit 120 can then determine how to adjust the flow rates of fuel and/or air input into the fuel processing unit 114 and then the array 108 to generate the modified level of current output. Curves 150 and 154 (FIG. 1B) are a graphical representation of the stack performance of a particular type of supplier stack. The PCU 116 will monitor airflow via airflow sensors, the pressures via pressure sensors and temperatures via thermocouples. By monitoring these sensors which are placed throughout the system, the PCU can use a complex Proportional-Integral-Derivative (PID) control process to limit the fuel/temperature such that the voltage output from curves 150 and 154 are optimized.

In other implementations, the current from the fuel cell stack array 108 can be monitored either alone or together with the voltage, and the monitored value (or values) used together with the estimated relationship between the voltage and the current used to determine the air and fuel flowrates necessary to meet the required power output.

In some implementations, the reformer reactor 113 is a CPOx reactor and each fuel cell stack 107 includes at least one SOFC. In such implementations, the control unit 120 is operable to control the feed rates of hydrogen rich gas and/or oxygen to the fuel cell stack array 108 to maintain a substantially constant output of power for at least 9 months.

In other implementations, the control unit 120 is operable to control the feed rates of hydrogen rich gas and/or oxygen to each fuel cell stack 107 in the array 108 on a stack-by-stack basis. In such implementations, the control unit 120 can monitor variables of each stack 107 on a stack-by-stack basis, and accordingly adjust operating parameters for each stack 107 based on the corresponding information obtained from monitoring the particular stack 107.

In the example implementation described, the fuel 104 is natural gas or methane. However, other fuels can be used, including without limitation, propane, diesel or gasoline. Using empirical data obtained from experimental tests, the air to fuel ratio at which coking will occur can be determined. With this information, the PID loop monitors the output and determines if a coking state starts to occur, the PID control loop would automatically attempt to adjust the fuel and air flowrates until the issue is resolved.

In some implementations, the power generation system 100 can include a battery bank 160. This battery bank would be used primarily for startup conditions and steady state conditions. It can also be used as a supplementary system to condition power spikes and dips in load-following situations. Secondly, the load on the power generation system 100 may vary during the course of a day. Accordingly, if the power output is substantially constant, the battery bank 160 can be used to soak up the spikes in demand. The battery bank 160 can be charged by the output from the PCU 116 and provide a reliable flow of electricity when needed.

In some implementations, the system 100 can optionally include a self-diagnostic unit 170. The self-diagnostic unit can be operable to with the controlling system 120, ensure that all sensors are functioning adequately/properly. Optionally, the system 100 can include a network connection 180, either wired or wireless, to permit operating parameters of the system 100 to be monitored and/or adjusted remotely. For example, the network connection can be a VPN (virtual private network) connection. The PCU software will attempt to diagnose a failure and provide information about possible fixes. Additionally, upon power up the system will go through a self check making sure that it has connections to all sensors and that the initial values for those sensors fall within predefined limits. If a sensor or valve or other component do not report the proper value an error code will be given to the HMI unit and the system will be locked out. The system will likely include an Ethernet connection and support its own encrypted webpage for monitoring purposes. To augment Ethernet GSM, CDMA, and UMTS options will be available for long range wireless monitoring.

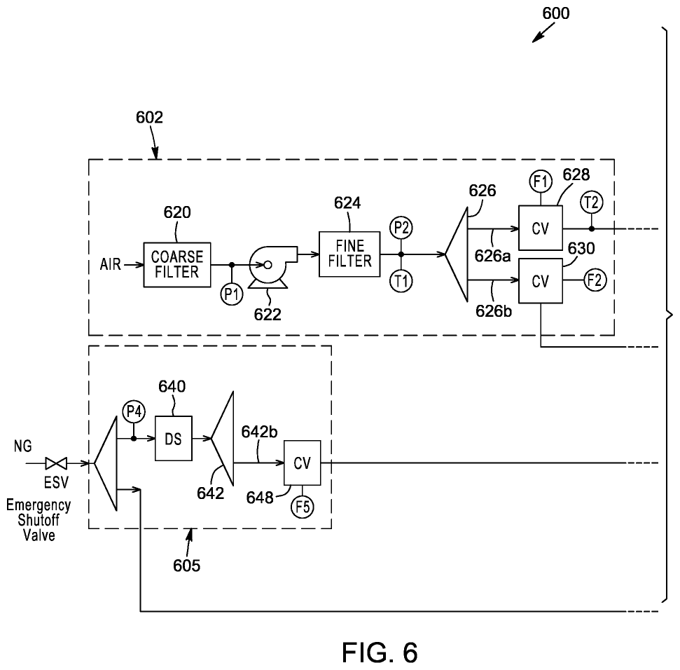

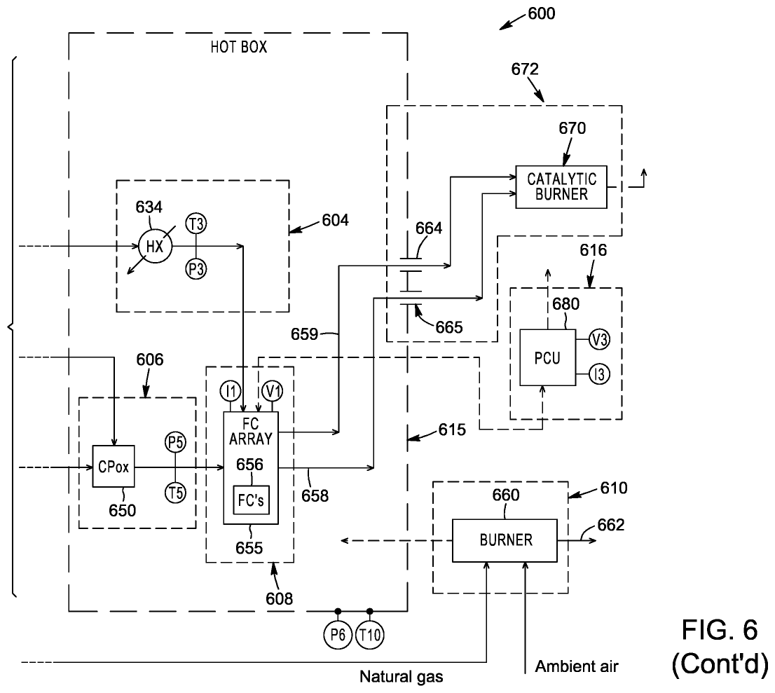

FIG. 6 illustrates a specific embodiment of a power generation system 600. In this embodiment, the power generation system 600 is a water-independent system in that water is not used as a feed to the power generation system 600. The generation system 600 may in this embodiment use air as a source of oxygen, natural gas as a source of fuel, a CPOx reformer and SOFC's. Other suitable types of fuel and oxygen sources may be used.

Referring to FIG. 6, the power generation system 600 may comprise an air delivery system 602, an air preheat system 604, a fuel delivery system 605, a fuel processing system 606, a fuel cell system 608, a burner system 610, an exhaust gas system 672 and a power conditioning unit (PCU) system 616. The air preheat system 604, the fuel processing system 606, the fuel cell system 608, the burner system 610 may be disposed in a hot box 615. For this system layout, the burner system 610 is primarily outside the hotbox with the combustion chamber sitting within the hotbox for the only purpose of preheating the hotbox on startup and keeping the hotbox at operating temperature during zero load conditions.

The air delivery system 602 may comprise a first filter 620, a blower 622, a second filter 624 and a manifold 626. The first filter 620, blower 622, second filter 624 and manifold 626 may be connected or otherwise coupled together in series. In one embodiment, the first filter 620 may comprise a coarse filter for filtering ambient air prior to blower 622. In this embodiment, the second filter 624 may comprise a fine filter for further filtering air output by the blower 622. A pressure sensor P1 may be located at the outlet of the coarse filter to sense air pressure at that point. A pressure sensor P2 may be located at the outlet of the fine filter 624 to sense air pressure at that point. A temperature sensor T1 may also be located at the outlet of the fine filter 624 to sense temperature at that point. Air pressure sensors P1 and P2 may be used to determine if the first or second air filter 620 or 624 needs replacement and if the blower 622 is operating properly. Air temperature sensor T1 may be used in connection with downstream temperature sensor to control and/or determine the operational condition of the power generation system 600 and/or components of the system.

In one embodiment, the air manifold 626 includes an air feed 626a to the air preheat system 604, an air feed 626b to the fuel processing system 606. Air feed 626a may be connected to air preheat system 604 via control valve 628. Control valve 628 controls cathode air to the fuel cell system 608. Air feed 626b may be connected to fuel processing system 606 via control valve 630. Control valve 630 controls CPOx air to the fuel processing system 606. The air feeds and associated valves may be connected or otherwise coupled together in parallel in this embodiment.

Control valve 628 may include flow sensor F1 to sense and regulate flow of air through the valve. Control valve 630 may include flow sensor F2 to sense and regulate flow of air through the valve. In addition, a temperature sensor T2 may located at the outlet of control valve 628 to sense the temperature of the air entering the air preheat system 604. The sensors may also be used alone, together and/or with other sensors to control and/or determine the operational condition of the power generation system 600.

The air preheat system 604 may comprise a single or multiple heat exchangers 634. The heat exchanger 634 may be connected to and receive air via the air cathode control valve 628. In one embodiment, the heat exchanger 634 may be a primary heat exchanger. In this embodiment, the heat exchanger 634 may be connected or otherwise couple together in series with the first, or primary, heat exchanger 634 heating air to a temperature slightly below that of the fuel cell system 608 operating temperature. The heat exchanger 634 may comprise a series of coils, shell and tubes, plate and fins and/or other suitable components and configurations operable to use heat generated by the power generation system 600 to heat air for the fuel cell system 608. A temperature sensor T3 may be located at the outlet of the heat exchanger 634 to sense the temperature of the air at that point and/or after primary heating. A pressure sensor P3 may also be located at the outlet at the heat exchanger 634 to sense the pressure of the air at that point, after preheating and/or entering the fuel cell system 608. The sensors may also be used alone, together and/or with other sensors to assist in the control and/or determine the operational condition of the power generation system 600.

The fuel delivery system 605 may comprise a desulphurizer 640 and a fuel manifold 642. The desulphurizer 640 and the fuel manifold 642 may be connected or otherwise coupled in series. The desulphurizer 640 removes sulphur compounds from the fuel at the inlet of the power generation system 600. The fuel may comprise natural gas, methane, propane or other hydrocarbon fuel from a pipeline or other suitable source. The fuel may be in a gaseous or other suitable form, such as, for example, another type of fluid as long as the reformer is designed for such fuels.

A pressure sensor P4 may be located at the inlet of the desulphurizer 640 to sense the pressure and/or the fuel gas flowrate entering the power generation system 600. Although not illustrated, the fuel delivery system 605 may include a pressure control valve or system to step down or up the pressure of fuel gas entering the desulphurizer 640. For example, if natural gas from a pipeline is used, the gas pressure should be stepped down from pipeline pressure to a lower pressure before entering the power generation system 600.

Control valve 648 may include flow sensor F5 to sense flow of fuel through the valve. The sensors may also be used alone, together and/or with other sensors to assist in the control and/or determine the operational condition of the power generation system 600.

The fuel processing system 606 may comprise a CPOx reformer 650. Other suitable reformers may be used in the water-independent embodiment of the power generation system 600. The CPOx reformer 650 receives air via CPOx air control valve 630 and fuel feed control valve 648. As previously described, the CPOx reformer 650 generates a hydrogen-rich fuel for the fuel cell system 608 using air and fuel provided by the air and fuel delivery systems 602 and 605.

A pressure sensor P5 may be located at the outlet of the CPOx reformer 650 to sense pressure and/or the hydrogen-rich fuel flowrate at that point and/or entering the fuel cell system 608. A temperature sensor T5 may also be located at the outlet of the CPOx reformer 650 to sense temperature of the hydrogen-rich fuel at that point and/or entering the fuel cell system 608. The sensors may also be used alone, together and/or with other sensors to assist in the control and/or determine the operational condition of the power generation system 600.

Fuel cell system 608 may comprise fuel cell array 655 connected to or otherwise coupled to the heat exchanger 634 to receive preheated air and to the CPOx reformer 650 to receive hydrogen rich fuel gas. Fuel cell array 655 may include one or more fuel cell stacks 656. The fuel cell stacks 656 may be arranged in a circular, oval, race track or other suitable configuration in the hot box 615. Each fuel cell stack 656 may comprise one or more fuel cells. As previously described, each fuel cell may utilize oxygen from the preheated air and the hydrogen-rich fuel to generate electricity. In a particular embodiment, each fuel cell is a SOFC as described in connection with FIGS. 3A and 3B. In other embodiments, the fuel cells may comprise of phosphoric acid fuel cells (PAFCs), molten carbonate fuel cells (MCFCs), proton exchange membranes (PEMs), alkaline fuel cells (AFCs), direct methanol fuel cells (DMFCs), and protonic ceramic fuel cells (PCFCs) or solid oxide electrolyzer fuel cells (SOECs).

A current sensor or multiples I1 may be located at the fuel cell stacks 656 to sense and regulate current at that point and/or generated by the fuel cell stacks 656. A voltage sensor or multiples V1 may be located at the fuel cell stacks 656 to sense and regulate voltage at that point and/or generated by the fuel cell stacks 656. The sensors may also be used alone, together and/or with other sensors to control and/or determine the operational condition of the power generation system 600. The power generated by the fuel cell stacks 656 is provided to the PCU 616 via one or more electrical contacts.

In the illustrated embodiment, air exhaust 658 from fuel cell stacks 656 is released into the hot box 615. Any unconsumed fuel exhausted 659 by the fuel cell stacks 656 may be burned by the catalytic burner 670. The burner system 610 may comprise of an independent burner 660. The burner 660 receives air independently from the environment through its own independent control system. The burner 660 may be used to preheat the hot box 615 during start-up of the power generation system 600 and maintain the hotbox environment temperature at an adequate operating temperature between 550° C. and 775° C. Other suitable types of burners, pilots, and/or heater may be used for the burner system 610 without departing from the scope of the present technology. Exhaust 662 from the burner 660 is also released into ambient environment.

In the illustrated embodiment, the hot box 615 includes the heat exchanger 634 of the air preheat system 604, the CPOx reformer 650, the fuel cell stacks 656, and the fuel cell stack support structure including the air inlet header, fuel inlet header, fuel exhaust header, flame sensors, current collectors, etc. The hot box may include other, additional or fewer components in other embodiments. The hot box 615 may, as described in more detail below, operate at a temperature of about 725° C. to 775° C. and at a pressure slightly above atmospheric. The hot box 615 may in other embodiments operate at other suitable temperatures and pressures. The hot box 615 may be sized and shaped to optimize or enhance the temperature of the thermal integration in the hot box 615 as well as other operational characteristics.

The hot box 615 may include a temperature sensor T10 to sense the temperature of the hot box 615. A pressure sensor P6 may also be included to sense pressure of the hot box 615. The sensors may also be used alone, together and/or with other sensors to assist in the control and/or determine the operational condition of the power generation system 600.

The PCU system 616 comprises PCU 680. The PCU 680 received power from the fuel cell stacks 656. As described above, the PCU 680 conditions power for use by the power generation system 600 and for provision to the batteries for charging. The batteries then provide the electrical power to the client or user load.

The current sensor(s) I3 may be located at the PCU 680 to sense current at that point and/or produced by the PCU 680 or the power generation system. The voltage sensor(s) V3 may also be located at the PCU 680 to sense voltage at that point and/or generated by the PCU 680. The sensors may also be used alone, together and/or with other sensors to assist in the control and/or determine the operational condition of the power generation system 600.

Each of the control valves of the system 600 may be a metering valve operable to precisely meter a gas or liquid or other suitable fluid. In this embodiment, the metering valves may be fully controllable between 0 and 100% open and closed. In another embodiment, one or more of the control valves may be two position valves with only an open position and a close position.

The pressure, temperature, flow, current and voltage sensors may be wired to a control system for the power generation system 600 or otherwise suitably communicate with the control system. For example, one or more of the sensors may be wireless sensors that communicate wirelessly with the control system of power generation system 600. The wireless or wired sensors may communicate directly with the control system or may communicate with the control system over network such as a local area network in the power generation system 600. Other, additional or fewer sensors may be used or otherwise arranged in the power generation system 600.

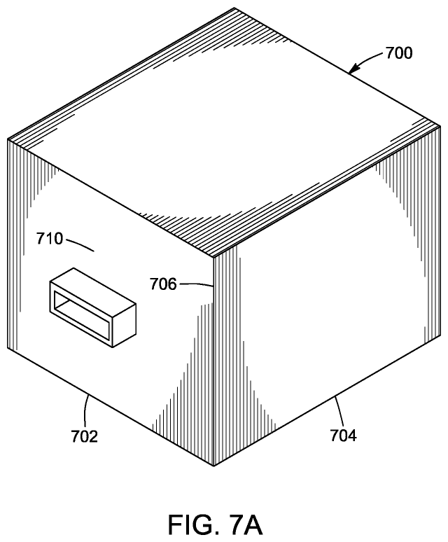

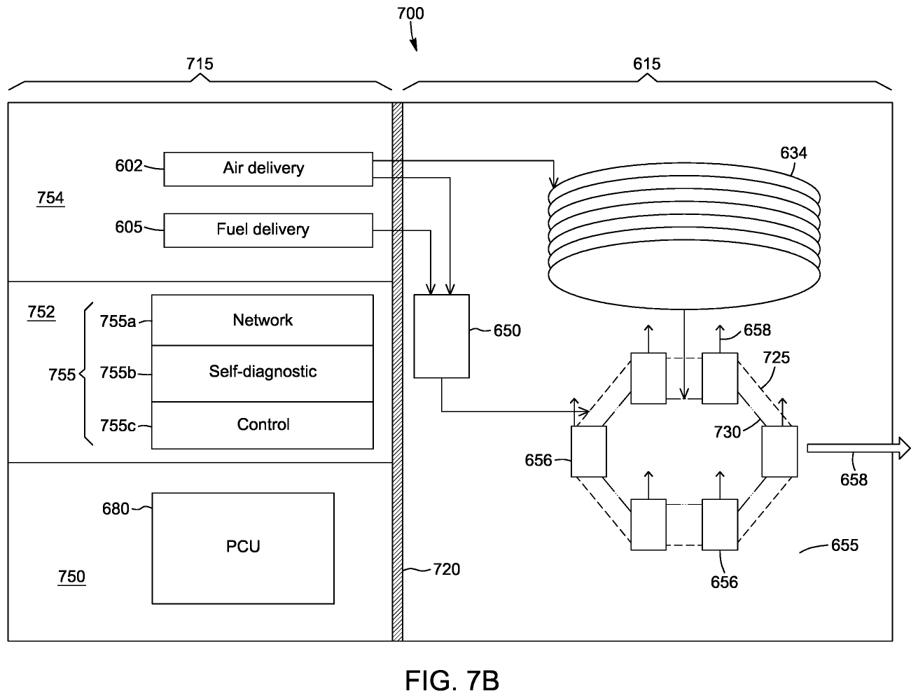

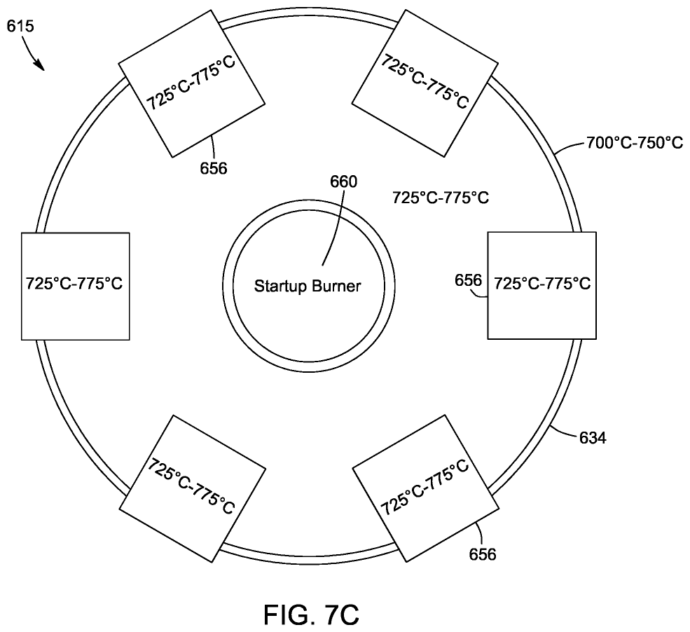

Referring to FIG. 7A, the power generation unit 700 may also be self-contained, integrated and/or and transportable and/or mobile as a single unit. In the illustrated embodiment, the power generation unit 700 may have a width 702, a depth 704 and a height 706. In a particular embodiment, the width may be approximately 3.5 feet, the depth approximately 5.5 feet and the height approximately 3.5 feet. An exhaust port 710 may extend from the top and from the top of the power generation unit 700. In this embodiment, the power generation unit 700 may have a small footprint and may be easily ported to remote areas and into high density urban areas for installation and use. For example, the power generation unit 700 may in one embodiment weight approximately 280 to 300 kilograms.

Referring to FIG. 7B, the power generation unit 700 may include the hot box 615 and a cold zone 715. In one embodiment, the hot box 615 may operate at temperatures of about or at 725° to 775° C. while the cold zone remains about or at or below 50° C. In this embodiment, the hot box 615 may be separated from the cold zone 715 by an insulated wall 720.

The hot box 615 may, as previously described, include the CPOx reformer 650, fuel cells stacks 656 and the air heat exchanger 634. The catalytic burner 670 may be disposed outside of the hotbox to burn any unconsumed part of gas 658 exhausted by the fuel cell stacks 656. The elements of the power generation unit 700 in the hot box 715 may be otherwise suitable configured and arranged.

In the illustrated embodiment, the fuel cell array 655 comprises six SOFC stacks 656 arranged in a circle or otherwise substantially equidistant from each other. The heat exchanger 634 may be connected or otherwise suitable coupled to the air delivery system 602 and comprise a set of coils wrapped around the burner combustion chamber and above the fuel cell array 655. Preheated air from the heat exchanger 634 may flow to a fuel cell air manifold 725 for distribution to the SOFCs 656.

Fuel enters the hot box 615 via the fuel delivery system 605 and is fed to the CPOx reformer 650 along with air from the air delivery system 602. At the CPOx reformer, the fuel is converted into a hydrogen-rich fuel which is provided to a fuel manifold 730 for distribution to each fuel cell stack 656. Oxygen and fuel may be otherwise suitably distributed or provided to the fuel cell array 655 and/or SOFC's 656.

Exhaust gases 658 from the SOFC's 656 are released into the hot box 615 and may exit the hot box 615 via port 664 and port 665 (FIG. 6). The exhaust gas system 672 (FIG. 6) may be located on the side of the hot box 615, in the hot zone 615, in the exhaust port 710 (FIG. 7A), or otherwise suitably.

The cold zone 715 may be divided into a plurality of sections. For example, in the illustrated embodiment, PCU 680 of the PCU system 616 may be disposed in a first section 750 of the cold zone 715 while a control system 755 is disposed a second section 752 and the air and fuel delivery systems 602 and 605 are disposed in a third section 754. Although not shown, the PCU 680 includes one or more external or internal electric ports for connecting and powering a load.

The control system 755 may comprise a network sub-system 755a, self-diagnostic sub-system 755b and a control sub-system 755c. Control system 755 may be implemented by one or more computers or processors or processing devices including suitable media storing instructions for complete operation of the power generation unit 600. The control system 755 may, for example, comprise persistent or nonpersistent memory encoded with software code for operating the unit 700.

The network sub-system 755a may comprise an internal network for communicating with sensors and other elements in the power generation unit 700 and a transceiver and/or other devices for communicating within a wide area network such as a telephone network, cell telephone network, a wireless network, satellite network, the Internet, a broadband network or other suitable network. The network sub-system 755a may allow the power generation unit 700 to be wholly or partially operated remotely over a network link or connection, be partially programmed remotely and/or be monitored remotely. The network sub-system 755a may also upload information on operation of the power generation unit 700 to a remote control or monitoring station and/or download software or firmware updates.

The self-diagnostic sub-system 755b may perform diagnostics on the power generation unit 700 during start-up, pre-run, run, and/or shut down modes. The self-diagnostic sub-system 755b may notify the control sub-system 755c of any problems within the power generation unit 700 and may upload error and other diagnostic messages to a remote station using the network sub-system 755a.

The control sub-system 755c may control operation of the power generation unit 700, including start-up, pre-run, run and/or shut down modes. For example, the control sub-system 755c may take action in the power generation unit 600 in response to or based on data and information from sensors and/or from the self-diagnostic sub-system 755b, the network sub-system 755a or other unit, device or system. Thus, the control sub-system may process messages and information based on the content or structure of the information and take or not take one or more actions based on the content, structure or timing of the information. The message or information may be any data sent from or to any sensor or device in or outside the unit 700. The control sub-system 775c may shut down the unit 700 in response to a problem indicated by self-diagnostic sub-system 755b. The control sub-system 755c may control the air and fuel delivery systems 602 and 605 to control power generated by the power generation unit 600 and to control the voltage and current of the power generated by the unit 600.

Referring to FIG. 7C, the hot box 615 includes in the illustrated embodiment the burner 660 disposed substantially at the center of the hot box 615. In this embodiment, the SOFC's or other type of fuel cell stacks 656 are disposed around, but vertically above the burner 660 or otherwise vertically displaced from the burner 660. In operation, the burner 660 and the SOFC's 656 each operate at a temperature of approximately of 725° C. to 775° C. Air in the heat exchanger 634 may be heated to a final temperature of about 50° C. below the stack operating temperature before entering the fuel cell stacks 656. Thus, the final temperature for a CPOx/SOFC embodiment may vary by 10° C., 20° C. or, 50° C. Other embodiments may operate at other suitable temperatures. It will be understood that the SOFC or other fuel cell stacks 656 may be otherwise disposed relative to each other and to the burner 660. In addition, the air heat exchanger 634 may be otherwise configured or disposed within the hot box 615 or relative to the fuel cell stacks 656 or the burner 660. The hot box 615 may be maintained in a temperature range of 725° C. to 775° C.

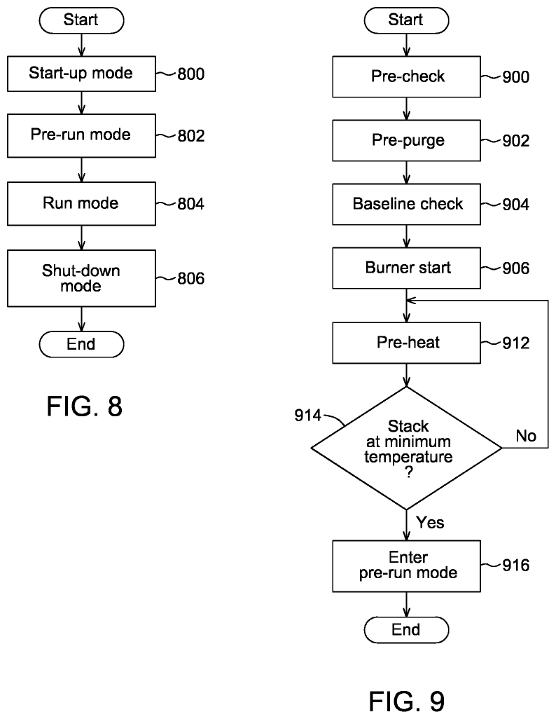

FIG. 8 is a flow diagram illustrating a method of operating a power generation system in accordance with one embodiment of the disclosure. In this embodiment, the power generation system is the power generation system 600 as implemented in the power generation unit 600. The power generation system 600 may be otherwise suitable operated. For example, the power generation system 600 may be operated with additional, fewer or disparate steps. Further, one or more of the steps may be combined, separated into separate steps, performed wholly or partially in parallel and/or otherwise suitably performed. The method may stay in and/or transition from and/or transition to a different step and/or mode at different conditions or based on disparate criteria. In addition, other power generation systems comprising other types of reformer or fuel cell and/or a disparate configuration may be co-operated.

Referring to FIG. 8, the method begins at step 800 in which the power generation system 600 enters start-up mode. As described in more detail below in connection with FIG. 9, the control system 755 of the power generation system 600 may start the burner 660 in the start-up mode. In addition, the control system 755 may perform various checks and run diagnostics on various elements of the power generation 600 during start-up mode.

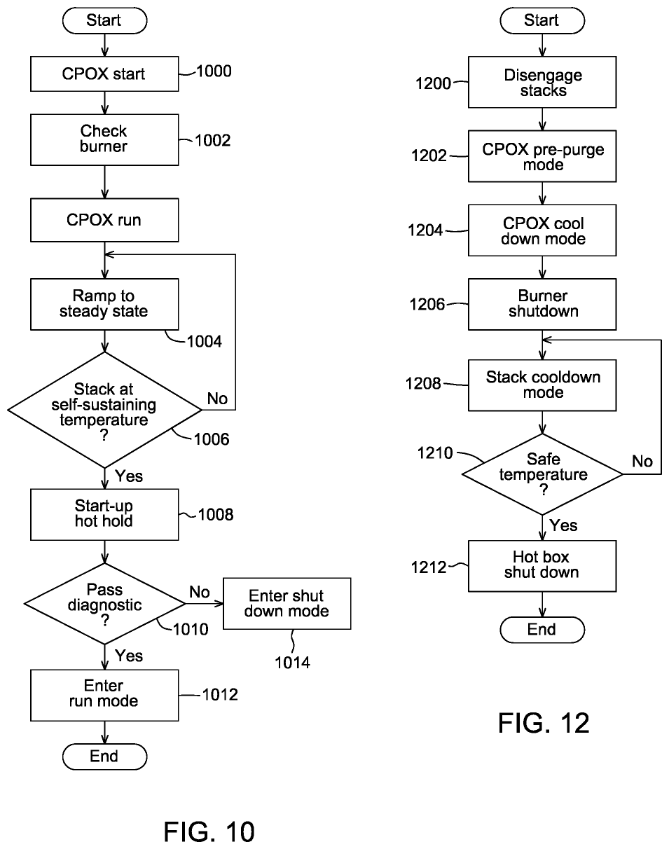

Next, at step 802, after successful completion of start-up mode, the power generation system 600 may enter the pre-run mode. As described in more detail below in connection with FIG. 10, the control system 755 may in the pre-run mode start the CPOx 650 and the Burner 660 and ramp up temperatures in the hot box 615 to a steady state.

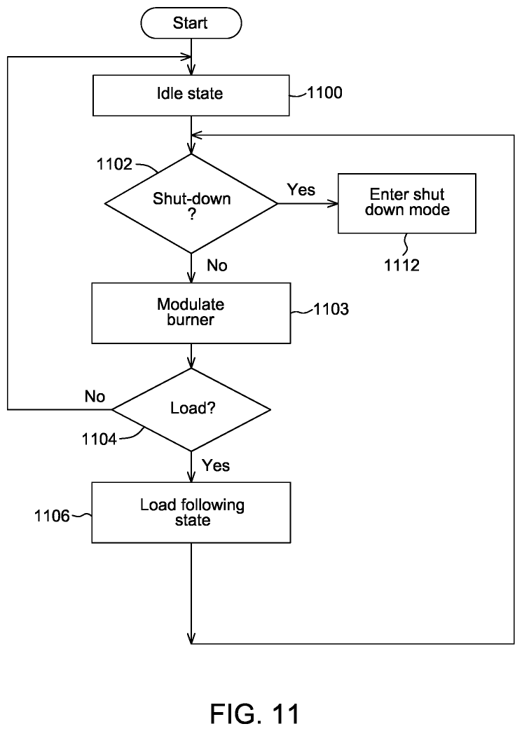

At step 804, the power generation system 600 enters the run mode. In a particular embodiment, when temperature of the hot box 615 reach a minimum self-sustaining temperature, the power generation system 600 may go into a hot hold state and enter the run mode. In the run mode, as described in more detail below in connection with FIG. 11, the power generation system 600 may operate at hot hold as a baseline and initiate load following. In a particular embodiment, the PCU 680 may monitor the output power requirements and the control system will adjust the fuel and air flows in the air and fuel delivery systems 602 and 605, in the fuel processing system 606 and/or in the fuel cell system 608 to meet demands for internal and/or output power.

In response to a shut-down event, the power generation system 600 may enter shut-down mode at step 806. As described in more detail below in connection with FIG. 12, in the shut-down mode the CPOx 650 and SOFCs 656 may be gradually cooled and then shut down. In addition, the CPOx 650 and SOFCs 656 may be purged using air to prevent damage to the power generation system 600.

FIG. 9 is a flow diagram illustrating a method for performing the start-up mode of FIG. 8 in accordance with one embodiment of the disclosure. In this embodiment, the control system 755 may perform start-up mode steps either directly or indirectly by controlling other devices. The start-up mode may include additional, fewer or disparate steps. In addition, one or more of the steps may be combined, separated into separate steps and/or performed in a different order or wholly or partially in parallel. The method may stay in and/or transition from and/or transition to a different step and/or mode at different conditions or based on disparate criteria. Further, one or more or all of the steps may be performed by other elements and/or systems of the power generation system 600.

Referring to FIG. 9, the start-up mode begins at step 900 with a pre-check of the power generation system 600. In one embodiment, the control system 755 performs the pre-check by performing a self-diagnostic procedure and checking all the sensors and electrical components for correct range and operation.

Next, at step 902, the control system 755 performs a pre-purge of the power generation system 600. In one embodiment, the control system 755 performs the pre-purge by starting the blower 622 which blows ambient air through the power generation system 600 to exhaust any fumes that may have accumulated in the power generation system 600. In one embodiment, the pre-pure may last for approximately one minute.

At step 904, a baseline check is performed by the control system 755. In one embodiment, one, more or all pressure, temperature and flow sensor readings are logged for an operational baseline at the baseline check. Next, at step 906, the control system 755 starts the burner 660. In one embodiment, the control system 755 activates the burner igniter (not shown) and controls the burner output using the factory provided fuel control valve. The burner igniter ignites the excess air mixture in the burner to begin preheating the burner and the hot box 615.

Proceeding to step 912, the power generation system 600 enters a start-up pre-heat mode. In the preheat mode, the control system 755 may open the cathode air control valve 628 to allow air to flow through the air heat exchanger 634 to collect heat from the burner 660 and preheat air entering the SOFCs 656. Air flow in cathode air control valve 628 and fuel flow in CPOx fuel control valve 648 may be adjusted to balance the temperatures entering the cathodes and anodes of SOFC's 656, respectively.

Next, at decisional step 914, if the SOFCs 656 have not reached a minimum temperature, the No branch returns to step 912 and stack temperatures continue to increase. When temperature of the SOFCs 656 reach a minimum or other suitable level, the Yes branch of decisional step 914 leads to step 916 in which the power generation system 600 exits the start-up mode and enters the pre-run mode. In one embodiment, the minimum required temperature to enter pre-run mode is 550° C. The minimum required temperature may be other suitable temperatures. In addition, other or additional criteria may be used to transition from the start-up mode to the pre-run mode.

FIG. 10 is a flow diagram illustrating a method for performing the pre-run mode of FIG. 8 in accordance with one embodiment of the disclosure. In this embodiment, the control system 755 may perform the pre-run mode steps either directly or indirectly by controlling other devices. The pre-run mode may include additional, fewer or disparate steps. In addition, one or more of the steps may be combined, separated into separate steps performed wholly or partially in parallel and/or performed in a different order. The method may stay in and/or transition from and/or transition to a different step and/or mode at different conditions or based on disparate criteria. Further, one or more or all of the steps may be performed by other elements and/or systems of the power generation system 600.

Referring to FIG. 10, the pre-run mode begins at step 1000 with the CPOx 650 transitioning to run mode. In a particular embodiment, the control system 755 monitors temperatures in the SOFCs 656. When temperatures in the SOFCs 656 have reached the minimum level, the control system 755 reduces air flow through CPOx air control valve 630 at step 1000 to initiate fuel production for the SOFCs 656.

Next, at step 1002, the control system 755 may keep burner 660 operating. In a particular embodiment, the control system 755 may activate the burner igniter, then allow the burner to operate autonomously in terms of fuel and air flow required. The burner 660 operates at near to or at complete combustion to ensure maximum heat input into the hotbox through a stoichiometrically balanced combustion reaction of the fuel. This burner operation will continue until steady state conditions (primarily temperature) in the power generation system 600 and/or the hot box 615 are achieved.

At step 1004, the power generation system 600 may be ramped to a steady state. In a particular embodiment, as fuel and air are utilized in the SOFCs 656, heat given off by the stacks 656 overcomes the temperature drop in the CPOx 650 and the hot box 615 temperatures continue to increase until steady state conditions are achieved.

Next, at decisional step 1006, the control system 755 may determine if the SOFCs 656 have reached a self-sustaining temperature. In one embodiment, the self-sustaining temperature is between 550° C. and 800° C. or between 550 and 600° C. The self-sustaining temperature may be other suitable temperatures. If the self-sustaining temperature is not yet reached in the SOFCs 656, the No branch of decisional step 1006 returns to step 1004 where the power generation system 600 continues to ramp to steady state. When the SOFCs 656 reach the self-sustaining temperature, the Yes branch of decisional step 1006 leads to step 1008.

At step 1008, the power generation system 600 may enter start-up hot hold. When entering start-up hot hold, extensive self-diagnostics routines may be run at decisional step 1010 to verify all systems are operating normally and/or operating at an acceptable level. If all systems are operating normally, the Yes branch of decisional step 1010 may lead to step 1012 where the power generation system 600 enters run mode. If one or more systems are not operating normally and/or are operating below a threshold level, the No branch of decisional step 1010 may lead to step 1014 where the power generation system 600 enters shut-down mode. Alternatively, for example, the power generation system 600 may maintain at hot hold and the control system 755 communicate an error message to a remote monitoring and control station via the network 755a to allow corrective action. If the error can be remotely fixed, the power generation system 600 may then and/or after completing additional ore repeating previous steps enter run mode without first shutting down.

FIG. 11 is a flow diagram illustrating a method for performing the run mode of FIG. 8 in accordance with one embodiment of the disclosure. In this embodiment, the control system 755 may perform the run mode steps either directly or indirectly by controlling other devices. The run mode may include additional, fewer or disparate steps. In addition, one or more of the steps may be combined, separated into separate steps, performed wholly or partially in parallel and/or performed in a different order. The method may stay in and/or transition from and/or transition to a different step and/or mode at different conditions or based on disparate criteria. Further, one or more or all of the steps may be performed by other elements and/or systems of the power generation system 600.

Referring to FIG. 11, the run mode method begins at step 1100 wherein the power generation system 600 is in an idle state of the run mode. In a particular embodiment, the CPOx 650 and SOFCs 656 may be at hot hold when the power generation system 600 is in the run mode idle state. In this embodiment, the SOFCs may be generating power for internal use but not providing power to a load. In this mode, the system is in an idle state, where power will be used for the PCU and battery charging only. Once the stacks are up to temperature and are starting to enter their peak performance then the command from the controller will be issued to move to the run mode. Idle mode is where the power generation system produces 0 (zero) net power. Hot hold mode is where the power generation system produces 0 (zero) gross power and the batteries are supplying all power to the electrical parasitics.

At any point while in the run mode idle mode, if a shut-down event occurs, the Yes branch of decisional step 1102 leads to step 1112 where the power generation system 600 enters the shut-down mode. A shut-down event may comprise, for example, detection of a fault in the power generation system 600, failure of a critical or other element, system or unit of the power generation system 600 failure of a component or system to pass self-diagnostics and/or a request from the control system 755 if, for example, power is no longer needed. In one embodiment, in response to a shut-down event, the power generation system 600 may remain in its current state to allow an operator at a remote station to correct the fault without entering shut-down mode. If a shut-down event has not occurred, the No branch of decisional step 1102 leads to step 1103, modulation of the burner to maintain the hotbox within a certain operating temperature range.

At decisional step 1104, the control system 755 may determine if there is a requirement for output power. If at any time there is a requirement for output power, the Yes branch of decisional step 1104 leads to step 1106. If there remains no requirement for output power for a load, the No branch of decisional step 1104 returns to idle state at step 1100.

At step 1106, the control system 755 may monitor the output power requirements of the load (via PCU 680 or otherwise) and adjusts fuel and air flows accordingly in the power generation system 600 to meet load demands for charging the batteries which supply power to the required load. While in the load following state, the control system 755 additionally modulates the burner 660 at step 1108. In particular, the burner output 662 may be modulated between off and full output to maintain the hot box 615 temperature and to ensure sufficient heat is supplied to the stacks while the unit is in hot hold.

FIG. 12 is a flow diagram illustrating a method for performing the shut-down mode of FIG. 8 in accordance with one embodiment of the disclosure. In this embodiment, the control system 755 may perform the shut-down mode steps either directly or indirectly by controlling other devices. The shut-down mode may include additional, fewer or disparate steps. In addition, one or more of the steps may be combined, separated into separate steps, performed wholly or partially in parallel and/or performed in a different order. The method may stay in and/or transition from and/or transition to a different step and/or mode at different conditions or based on disparate criteria. Further, one or more or all of the steps may be performed by other elements and/or systems of the power generation system 600.

Referring to FIG. 12, the method begins at step 1200 in which the SOFCs 656 may be disengaged. In one embodiment, the control system 755 may electrically disengage the SOFCs 656 from the PCU system 616. At step 1202, the CPOx 650 may enter pre-purge mode. In one embodiment, the control module 755 may adjust the air and fuel flow to the CPOx 650 via CPOx air and fuel control valves 630 and 648 to restore an excess air mixture in the CPOx 650 to stop production of fuel for the SOFCs 656 while maintaining cathode and anode inlet temperatures in the stack.

Next, at step 1204, the CPOx 650 may enter cool down mode. In a particular embodiment, the control module 755 may adjust the cathode air via control valve 628 to control air flow through the air heat exchanger 634 to collect residual heat from the CPOx 650 and burner 660 and gradually cool down the air entering the cathodes of the SOFCs 656. In this embodiment, SOFC air (cathode air) and CPOx fuel flows through control valves 628 and 648 may be adjusted to balance the temperatures entering the cathodes and anodes of the SOFCs 656 while simultaneously or otherwise reducing temperatures in the hot box 615. Flow of air through CPOx air control valve 630 may be controlled to maintain an excess air condition in the CPOx 650.

Next, at step 1206, the burner 660 may be shut-down. In a particular embodiment, the control module 755 may deactivate the pilot igniter of the burner 660 and close burner air and fuel control valves supplied with the burner assembly. At step 1208, SOFCs may be cooled down. In a particular embodiment, the control module 755 may adjust the cathode air control valve 628 which flows through the air heat exchanger 634 to continue to collect residual heat from the CPOx 650 and gradually cool down the balance of plant. The control module 755 may also close CPOx air control valve 630 and CPOx fuel control valve 648 to stop reactions in the CPOx 650.

Proceeding to decisional step 1210, if the hot box 615 has not yet reached a safe temperature, the No branch returns to step 1208 where cool down of the SOFC stack continues. In one embodiment, the safe temperature may be 35° C.-40° C. When the hot box 615 has reached the safe or other suitable temperature, the Yes branch of decisional step 1210 leads to step 1212. At step 1212, the hot box 615 may be shut down. In one embodiment, the control system 755 turns off air blower 622, closes the cathode air valve 628 and closes the Emergency Shutoff Valve (see FIG. 6). Step 1212 leads to the end of the shut-down mode by which the power generation system 600 is safely shut down from operation. The hot box 615 can also include a change in layout from the stack exhaust all the way to the power generation system 600 exhaust. The cathode exhaust (658) and anode exhaust (659) exiting the stack array 655 can be directly piped to the catalytic burner 670. With this configuration, no gases are exhausted directly into the hot box 615. In this embodiment, the hot box is equipped with a catalytic burner (670), which functions to ensure complete combustion of any residual hydrogen, carbon monoxide or other fuel species prior to being exhausted from the power generation system (600).

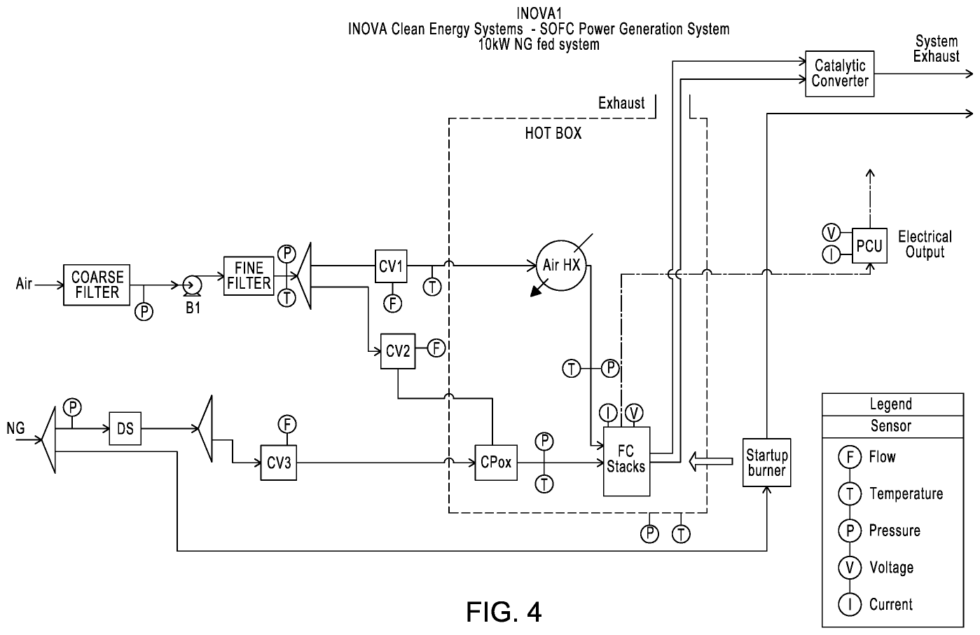

Referring to FIG. 4, this is an example of a flow diagram of an SOFC system. The main points of interest in this diagram are the number of components present in the system, the type of components used and in particular, the type, number and location of the sensors. The number of sensors may vary depending upon what variables are being monitored and controlled. An example of this is the fuel cell (FC) stacks. In general, one would use more than 2 voltage sensors per stack. The number of voltage sensors is dictated by the desired observable data points through the stacks. The greater the number of sensors, the more detailed voltage curve is for a particular FC stack.

The device or power generation system, can comprise the following:
a power generation module, the module comprising:
a reformer (POx) reactor operable to generate a hydrogen rich gas from a fuel; and
an array of one or more fuel cell stacks comprising at least one solid oxide fuel cell (SOFC), the array of fuel cell stacks coupled to the hydrogen rich gas source, reformer reactor and operable to generate electrical power and heat from an electro-chemical reaction of the hydrogen rich gas and oxygen from an oxygen source and provide the power to a load; and
a heat exchanger disposed proximate to the burner combustion chamber and above the plurality of fuel cell stacks, the heat exchanger operable to heat oxygen from an oxygen source to an operable level; and
a power conditioning unit (PCU) operable to receive and condition electrical power from the array of fuel cell stacks and provide at least 100 W power to an electrical load; and
a control unit operable to control a feed of hydrogen rich gas and a feed of oxygen to the array of fuel cell stacks to maintain a substantially constant output of power from the array of fuel cell stacks for at least 9 months; and
a heat source operable to warm the array of fuel cell stacks during a start-up operation; and
a controller operable to control operation of the power generation system, the controller including a self-diagnostic unit operable to detect a fault and to communicate the fault over a network to a remote location.

The power generation system described in 00125 comprises of the reformer reactor which can be a catalytic partial oxidation reactor (CPOx), partial oxidation reactor (POx) or other water-independant reformer. These reactors can generate heat adding to the heat produced by the array of fuel cell stacks. There are also water dependant reformers that can be used. These would include an autothermal reactor (ATR) or a steam reformer.

In the power generation system described in 00125, the heat generated can come from the array of fuel cell stacks includes radiant heat generated by the one or more fuel cell stacks and heat of combustion from exhaust gases produced by the one or more fuel cell stacks.

In the power generation system described in 00125, the fuel comprises of either natural gas, methane or propane. As well, each fuel cell stack comprises of a plurality of SOFCs. The reactor, whether POx, CPOx or ATR, is arranged within a thermal zone of the array of fuel cell stacks. These stacks can include a plurality of fuel cell stacks and the reactor involved is arranged within an area bounded by this plurality of fuel cell stacks. The array of fuel cell stacks includes six or more fuel cell stacks. The air heating system is disposed within the plurality of fuel cell stacks and the burner combustion zone. The air or oxygen preheat system is comprised of coils. In similar configurations, the air/oxygen preheat system can comprise of a shell and tube or plate and fin arrangements. The air/oxygen source is deliverable to each fuel cell stack at the same temperature, pressure and flowrate via a manifold.

In the power generation system described in 00125 and 00128, the oxygen source comprises air that is preheated to a temperature below that of the stack operating temperature.

In the power generation system described in 00125 and 00128, the device includes a power conditioning unit (PCU) operable to receive and condition electrical power from the array of fuel cell stacks into a usable format.

The power generation system described in 00125 and 00128, also includes one or more additional power generation modules, where the power generation modules together provide power to the load.

A method for generating electrical power for a load can comprises:
generating a hydrogen rich gas from a fuel by partially combusting a fuel in a reformer reactor, e.g., a partial oxidation (POx) reactor, or a catalytic partial oxidation (CPOx) reactor;
providing the hydrogen rich gas to an array of one or more fuel cell stacks;
providing oxygen or air to the array of fuel cell stacks; and
generating electrical power for a load and heat in the array of fuel cell stacks by oxidizing the hydrogen rich gas with oxygen using a solid oxide electrolyte.

The method described in 00132, which is for generating a hydrogen rich gas from a natural gas fuel by partially combusting the natural gas, methane or propane in a partial oxidation (POx) reactor, catalytic partial oxidation (CPOx) reactor or an autothermal reactor (ATR) or any other water dependent or independent reactor. The method also delivers air first to be preheated then provides oxygen to the solid oxide electrolyte.

The power generation system described in 00125, further comprising the power conditioning unit (PCU), is capable to provide electrical power from as low as 100 Watts up to a maximum of 10 kiloWatts to a particular load.

The power generation system described in 00125 and 00128 includes a control unit that is further operable to monitor a voltage and current output from the array of fuel cell stacks and to control the feed of hydrogen rich gas and oxygen/air based on the monitored voltage output to maintain the substantially constant output of power for at least 9 months.

The power generation system described in 00125 and 00128 includes a heat source such as a battery operated heater, gas-operated heater or the reformer reactor to preheat the array of fuel cell stacks during startup operation.

The power generation system described in 00125 and 00125, where the fault can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

The power generation system described in 00125 and 00128 includes an electronic system which incorporates a communication network which comprises either a telephone network, radio network or a satellite network.

The power generation system described in 00125 and 00128, includes one or more sensors in the power generation system, where the one or more sensors are operable to communicate with the self-diagnostic unit. These sensors can be wired or wireless sensors.

The power generation system described in 00125 and 00128, further comprising a remote control unit, where the remote control unit is operable to: communicate with the controller over the network; and transmit instructions to control operation of the power generation system to the controller over the network.

A power generation system can comprise:
a purchased reformer reactor operable to generate a hydrogen rich gas from a fuel;
an array of one or more purchased fuel cell stacks, each purchased fuel cell stack comprising at least one electrochemical fuel cell, the array coupled to the purchased reformer reactor and operable to generate electrical power and heat from an electrochemical reaction of the hydrogen rich gas and oxygen from an oxygen source; and
a purchased controller operable to control operation of the power generation system, the purchased controller including a self-diagnostic unit operable to detect a fault and to communicate the fault over a network to a remote location.

The power generation system described in 00125, 00128 and 00141 consists mainly of major components obtained from available suppliers. These off-the-shelf components reduces the overall cost of the power system by negating the need of customized componentry, which can be very expensive to manufacture and difficult to obtain and secure. By purchasing these componentries of the power generation system described in 00125, 00128 and 00141, utilization of such componentry reduces the operational complexity of an average power generation system. With the use of components described in 00125, 00128 and 00141, there is no need for specialized manufacturing facilities.

The power generation system described in 00125, 00128 and 00141, further comprising a purchased or supplied power conditioning unit (PCU) operable to receive and condition electrical power from the array of fuel cell stacks to provide the conditioned power to a load. The system also includes a purchased reformer reactor that generates heat. The power system generates an electrical power output in the range of approximately 0.1 to 10 kilowatts.

The power generation system described in 00125, 00128 and 00141, where the fault can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

The power generation system described in 00125, 00128 and 00141 incorporates an electronic system that includes a communication network comprising either a telephone network, radio network or a satellite network. This electronic system also includes one or more purchased sensors included in the power generation system, where the one or more purchased sensors are operable to communicate with the self-diagnostic unit. These sensors can either be wired or wireless.

The power generation system described in 00125, 00128 and 00141 also incorporates a remote control unit, where the remote control unit is operable to:
communicate with the controller over the network; and
transmit instructions to control operation of the power generation system to the controller over the network.

The hotbox within this power generation system uses only simplified parts. There are no parts within the hotbox that are integrated. These simple parts or non-integrated parts only have mechanical or process function. This signifies that these parts are significantly easier to control in terms of mechanical, chemical, process functions. An example of this is the main air heat exchanger coil, its function is to heat the air from ambient temperature to an acceptable operating inlet fuel cell stack temperature. With only one function, then the air heat exchanger can easily be controlled by changing the air flowrate.

Integrated parts have always been challenging to control. In this instance, the definition of integrated signifies a component that is composed of several other components or subsystems that includes the functionality of each of the subsystems into the functionality of the integrated component. An example of this is an integrated component that has the functionality of heating two different fluids and combusting two other fluids. This integrated component is basically composed of 2 heat exchanger subsystems and a combustion subsystem, so each of the heat exchanger subsystem has 2 inputs and two outputs and each subsystem has a single function of heating up a single fluid each. The combustion subsystem has two inputs and two outputs. This combustion subsystem has the single function of simply combusting the fluid mixture of resulting fluid which releases a certain quantity of heat and expulsing the resulting combusted fluids. As a result, the integrated component would have four inputs and four output streams and have the functionality of heating up 2 individual fluids and then mixing two other fluid streams, combusting that mixture and then expulsing the combusted stream. So, this integrated component is inherently more difficult to control because its control system must control the fluid flowrate of each of the fluids that need to be heated by the heat released from the combustion subsystem, it also must independently control the two input streams to the combustion subsystem. In this case, improper control of the two combustion subsystem inlet streams may result in incomplete combustion of the mixture of the two inlet streams, decreasing the heat released from the combustion subsystem, seriously decreasing the efficiency and effectiveness of each of the heat exchange functionality. So by separating these integrated components into separate components of simpler functionality, then these components are deemed decoupled on a physical level as well as a functionality level.

In point [00148] above, the terms of “integrated components” and “functionality” were explained. So by using simpler components with single or simplified functionality, it becomes easier to find, acquire or purchase these components or subsystems from manufacturing and distribution facilities. These companies generally have components that are designed with a functionality and performance adequate to the needs of a subsystem for a power generating system explained above. These available components are generally less expensive than if they were designed, created and manufactured inhouse. As a result, significant capital can be saved by purchasing (acquiring components by monetary exchange) these parts or components, making the power generation system less expensive to produce and/or manufacture. These parts or components that are already available at distribution facilities are deemed “off-the-shelf” components. The term off-the-shelf signifies a product (whether it's a component, part, subsystem etc) that is already designed, tested, proven safe and functional, and that it is available to be purchased and utilized.

In the context of this application, the term “purchased” signifies the acquisition of parts, components etc., through an exchange of money at a store, manufacturing facility or a parts distribution facility or in other words, buying parts or components. This is no different than purchasing batteries, books or tools at a local store. The purchase doesn't include buying the intellectual property, engineering services or other services.

Referring to points [00148], [00149] and [00150], when purchasing single function components from distribution companies, this has the bonus of reducing the overall cost of the bill of materials for the power system because highly customized parts and components are usually very expensive to produce and/or procure due to the specialized materials utilized in their design and manufacturing as well as the amount of engineering services that has gone into the design, manufacturing of these parts. As well, when ordering these non-integrated parts or components in large quantities, the distribution companies are able to offer volume discounts on a per unit basis, which further decreases the overall cost of the system. So, a single integrated module or component can be replaced by several simpler and less expensive components having only 1 functionality each. This change in componentry reduces the overall cost of the bill of material as well as simplify the control algorithm for the entire power generation system.

1. A power generation system, comprising:
a reformer (POx) reactor operable to generate a hydrogen rich gas from a fuel;
an array of one or more fuel cell stacks comprising at least one solid oxide fuel cell (SOFC), the array of fuel cell stacks coupled to the hydrogen rich gas source, coming from the reformer reactor and operable to generate electrical power and heat from an electro-chemical reaction of the hydrogen rich gas and oxygen from an oxygen source and provide the power to an electrical load;
a heat exchanger disposed proximate to a burner combustion chamber and above the plurality of fuel cell stacks, the heat exchanger operable to heat oxygen from an oxygen source to an operable level;
a power conditioning unit (PCU) operable to receive and condition electrical power from the array of fuel cell stacks and provide at least 100 W power to the electrical load;
a control unit operable to control a feed of the hydrogen rich gas and a feed of oxygen to the array of fuel cell stacks to maintain a substantially constant output of power from the array of fuel cell stacks for at least 9 months;
a heat source operable to warm the array of fuel cell stacks during a start-up operation; and
a controller operable to control operation of the power generation system, the controller including a self-diagnostic unit operable to detect a fault and to communicate the fault over a network to a remote location.

2. The power generation system of claim 1 wherein the reformer reactor is a catalytic partial oxidation reactor (CPOx), a partial oxidation reactor (POx), or a water-independent reformer.

3. The power generation system of claim 1, wherein the heat generated comes from the array of fuel cell stacks and includes radiant heat generated by the one or more fuel cell stacks and heat of combustion from exhaust gases produced by the one or more fuel cell stacks.

4. The power generation system of claim 1, wherein the fuel comprises natural gas, methane or propane; and
each fuel cell stack comprises of a plurality of SOFCs, these stacks can include a plurality of fuel cell stacks and the reactor involved is arranged within an area bounded by this plurality of fuel cell stacks;
the reactor, whether a POx, a CPOx or an ATR type reactor, is arranged within a thermal zone of the array of fuel cell stacks; and
the air heating system is disposed within the plurality of fuel cell stacks and the burner combustion zone.

5. The power generation system of claim 1, wherein the oxygen source comprises air that is preheated to a temperature below that of the stack operating temperature.

6. The power generation system of claim 1, further comprising a power conditioning unit (PCU) operable to receive and condition electrical power from the array of fuel cell stacks into a usable format for an appropriate load.

7. The power generation system of claim 1, further comprising one or more additional power generation modules, where the power generation modules together provide power to the electrical load.

8. A method for generating electrical power for a load, comprising:
generating a hydrogen rich gas from a hydrogen carbon fuel by partially combusting the fuel in a reformer reactor comprising a partial oxidation (POx) reactor or a catalytic partial oxidation (CPOx) reactor or a combination thereof;
providing the hydrogen rich gas to an array of one or more fuel cell stacks;
providing preheated oxygen or air to the array of fuel cell stacks; and
generating electrical power for a load and heat in the array of fuel cell stacks by oxidizing the hydrogen rich gas with oxygen using a solid oxide electrolyte.

9. The method of claim 8, which is for generating a hydrogen rich gas from a natural gas fuel by partially combusting the natural gas, methane or propane in the reformer reactor.

10. The power generation system of claim 1, further comprising the power conditioning unit (PCU) and is capable to provide electrical power from as low as 100 watts up to a maximum of 10 kilowatts to a particular load.

11. The power generation system of claim 1, further comprising the control unit that is further operable to monitor a voltage and current output from the array of fuel cell stacks and to control the feed of hydrogen rich gas and oxygen/air based on the monitored voltage output to maintain the substantially constant output of power for at least 9 months.

12. The power generation system of claim 1, wherein the heat source such as a battery operated heater, gas-operated heater or the reformer reactor to preheat the array of fuel cell stacks during startup operation.

13. The power generation system of claim 1, wherein the fault discovered by the diagnostic system, can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

14. The power generation system of claim 1, wherein an electronic system incorporates a communication network comprised either of a telephone network, radio network or a satellite network.

15. The power generation system of claim 1, wherein one or more sensors in the power generation system are operable to communicate with the self-diagnostic unit. These sensors are wired or wireless sensors.

16. The power generation system of claim 1, wherein a remote control unit is operable to: communicate with the controller over the network; and transmit instructions to control operation of the power generation system to the controller over the network.

17. The power generation system of claim 1, wherein a purchased or supplied power conditioning unit (PCU) operable to receive and condition direct current (DC) electrical power from the array of fuel cell stacks to provide the conditioned alternating current (AC) power for a load. The system also includes a purchased reformer reactor that generates heat. The power system generates an electrical power output in the range of approximately 0.1 to 10 kilowatts.

18. The power generation system of claim 1, wherein the diagnostic fault can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

19. The power generation system of claim 1, wherein an electronic system that includes a communication network comprising either a telephone network, radio network or a satellite network. This electronic system also includes one or more purchased sensors included in the power generation system, where the one or more purchased sensors are operable to communicate with the self-diagnostic unit. These sensors can either be wired or wireless.

20. The power generation system of claim 1, wherein a remote control unit, where the remote control unit is operable to:
communicate with the controller over the network; and
transmit instructions to control operation of the power generation system to the controller over the network. The power generation system of claim 1, where heat generated by the array of fuel cell stacks includes radiant heat generated by the one or more fuel cell stacks and heat of combustion from exhaust gases produced by the one or more fuel cell stacks.
